(19) United States
(12) Patent Application Publication
(10) Pub. No.: US 2015/0001324 A1
(43) Pub. Date: Jan. 1, 2015

(54) DEVICE AND METHOD FOR CRUSHING GLASS OBJECTS

(71) Applicant: NORDIC RECYCLE GROUP AB, Mariestad (SE)

(72) Inventor: Hasan Dagdelen, Orebro (SE)

(73) Assignee: NORDIC RECYCLE GROUP AB, Mariestad (SE)

(21) Appl. No.: 14/377,654

(22) PCT Filed: Feb. 7, 2013
(86) PCT No.: PCT/SE2013/050101

§ 371 Date: Aug. 8, 2014

(30) Foreign Application Priority Data
Feb. 9, 2012 (SE) 1250096-3

(51) Int. Cl. B02C 19/00; B02C 1/12; B02C 1/00; B02C 1/04

(52) U.S. Cl. CPC B02C 19/0087; B02C 1/043; B02C 1/12; B02C 1/005
USPC 241/30; 241/84

(57) ABSTRACT

The invention relates to a device for crushing glass objects comprising a first container (4) comprising a grid arrangement (12) with a plurality of elongated struts (11) mutually separated with space between the struts (11). The container may receive one or more glass objects that shall be crushed. The grid arrangement may allow pieces of crushed glass objects to pass. A frame (2) holds the first container and the crushing member (3). The crushing member comprises a first surface (9) that is directed towards the grid arrangement. The crushing member is configured to move between a first position (A) where the crushing member is outside the first container, and a second position (B) where the crushing member (3) is inside the first container, whereby the first container is configured for introduction of the crushing member. The first surface of the crushing member comprises one or more protruding elements (10), which protrude from the first surface and are configured to, in the second position (B), be inserted in the space between the struts of the grid arrangement.

### FIELD OF THE INVENTION

The present invention relates generally to a device for crushing glass objects. The invention especially relates to a device according to the pre-characterized portion of claim 1. Further, the invention relates to a method for crushing glass objects according to the pre-characterized portion of claim 9.

### BACKGROUND OF THE INVENTION AND PRIOR ART

Glass objects, such as empty glass bottles, can be recycled by crushing the glass and reusing the glass. To recycle glass, all the glass objects need to be collected in a space. Then they can be picked up for transport to a recycling business that processes the collected glass objects.

The collection of glass objects in shops, restaurants, hotels and the like is expensive and time consuming. First, all glass objects must be collected and then carried to a garbage room. In the garbage room all the glass objects are collected in piles before being picked up. The physical space needed for the collected glass is relatively large. Especially small restaurants and shops may have a problem with the space needed for the collection of the glass objects. Because picking up recycled glass costs money it may be uneconomical to request more pick ups of the glass objects.

One solution to the problem may be to crush the glass on site in, for example, shops and restaurants, before it is transported to the recycling business. Crushed pieces of glass from glass objects require less space then corresponding whole glass objects.

SE 440747 describes a device for crushing glass for recycling. The device comprises a frame extending along a vertical longitudinal axis with a first container, which comprises two, towards each other leaning crushing plates that form a funnel shaped opening and which lower edges form a gap, whereby the edges are mutually parallel. One of the crushing plates is rotatable around an axis. A glass object may be placed in the cavity between the crushing plates. By connecting a power means to the crushing plates, the plates can be pressed towards each other to crush the glass object in small pieces. A second container for the collection of the pieces of crushed glass is positioned under the first container.

U.S. Pat. No. 3,709,440 describes a device to crush a glass object where a frame holds a crushing member, which comprises two crushing plates that extend along a vertical longitudinal axis. One crushing plate is movably arranged. A glass object may be placed in the cavity between the crushing plates. A hydraulic activation member is used as a power means. The crushing plates are pressed together with their first surfaces directed towards each other to crush the glass object into pieces. The pieces of the crushed glass object fall down in a second container that is positioned under the crushing member.

DE 7222313 describes an apparatus for crushing glass comprising a first container which comprises a grid arrangement and a second container position under the grid. The volume of the first container can be filled by a crushing member, which is separately arranged. The crushing member needs to be removed from the first container before glass objects can be placed in the container. Crushing forces are applied manually.

U.S. Pat. No. 4,213,384 describes a device for crushing of glass objects whereby the glass objects are neatly piled in a first container. A crushing member, which is located inside a first container, comprises protruding elements on a first surface. The first surface is moved towards an opposite surface of the first container to crush the glass objects. Said opposite surface comprises openings to receive the protruding elements. Glass objects are supposedly pulverized by the device.

A disadvantage of most known apparatus for crushing glass is that they are adapted to crush one glass object at a time. For crushing of several glass objects bigger apparatus are usually required, which are possibly not suitable for placement in shops and the like.

Therefore, there is a need for a device, which allows crushing of glass objects in a simple and smooth way. Preferably, glass in all different thickness can be crushed. There is a need for a device for crushing glass, which reduces working efforts and space related to the collection of glass objects. Etiquettes on the glass objects do preferably not need to be removed prior to crushing. There is further a need for a device, which reduces costs related to recycling of glass. There is furthermore a need for a device, which can collect and crush several glass objects at the same time. There is in addition, a need for a device for crushing glass objects, which may be used continuously and in a safe manner. Preferably, an apparatus that can be used in shops, hotels and restaurants.

### SUMMARY OF THE INVENTION

The objects of the present invention is to provide a device for the crushing glass objects that overcomes the problems mentioned above.

The object is achieved by a device defined in the pre-characterized portion of claim 1, characterized in that the crushing member comprises a first surface that is directed towards the grid arrangement and the crushing member is configured to move between a first position and a second position, in which first position the crushing member is outside the cavity and in which second position the crushing member is inside the cavity, whereby the first surface of the crushing member is configured to abut against the grid arrangement,

whereby the upper opening of the first container is configured for introduction of the crushing member,

the first surface of the crushing member comprises one or more protruding elements that protrude from the first surface and are configured to, in the second position, be inserted in the space between the struts of the grid arrangement.

The device according to the present invention enables crushing glass objects in shops, restaurants, hotels and the like. The size of the device can be easily adjusted to the space where the device is to be placed. The device may be used in a simple and smooth way. The crushing member is positioned outside the first container prior to crushing the glass objects. Therefore, the glass objects can conveniently and continuously be placed in the first container. The glass objects do not need to be neatly piled up in the first container. The device can be used without any need for cleaning the glass or need to remove etiquettes prior to crushing glass in the device. Even thick glass, such as bottom of champagne bottles, can be crushed in the new device. Work efforts and spaces related to the collection of glass objects reduce with help of the new device. As the collected crushed glass require less space, the glass to be recycled needs not be picked up as often. The device according to the present invention reduces costs by reducing work efforts, reducing garbage space and reducing number of pickups. The device benefits thereby the environment.

Another advantage of the invention is that several glass objects can be collected in the first container and that several glass objects can be crushed at the same time.

The first surface of the crushing member can be pressed against the struts. The protruding elements will be received in the spaces between the struts. Hereby, no layer of glass can be formed on top of the grid arrangement. Even thick pieces of glass can be crushed. Also, etiquettes on glass objects will be crushed together with the glass object and pass the grid. This has the advantage that the device can be used continuously without additional work efforts of employees for cleaning. The device may additionally be built in different sizes, where the sizes can be adapted to the available spaces present in the building where the device is to be used.

According to one embodiment of the invention, the crushing member is connected to a power means to provide a pressing force on the crushing member that enables crushing of glass objects in the first container.

According to another embodiment of the invention, the power means uses a larger pressing force in the second position compared to the pressing force used in the first position.

According to a further embodiment of the invention, the crushing member is adapted to move between a first level in the second position and a second level in the second position, in which second level the crushing member is closest to the grid arrangement, and whereby the power means uses a larger pressing force in the second level in the second position compared to the pressing force used in the first level in the second position.

The advantage of different pressing forces at different positions and levels of the crushing member is that all glass objects are crushed and that all pieces of the crushed glass objects pass the struts and thereby not form a layer on top of the struts. Thereby, even thick glass objects, such as bottoms of champagne bottles, and the like, and glass objects covered by sticky etiquettes can be crushed and will pass the spaces between the struts.

According to another embodiment of the invention, the device comprises a second container arranged under the grid arrangement for collecting pieces of crushed glass objects.

Pieces of crushed glass objects are collected preferably in a bag or a container, which can easily be replaced when it is full.

According to one embodiment of the invention, the frame comprises at least two side walls that extend along the longitudinal axis between a ground level and a top wall, whereby the top wall is connected to the side walls and extends along a substantially horizontal axis.

The frame may contain whole covering sides so that the device resembles a cabinet. The advantage of whole covering sides is a suppression of noise, which may occur during crushing and to prevent the risk for injuries by clamping.

According to another embodiment of the invention, the crushing member is movably connected to the top wall and/or one or more side walls.

The crushing member is movably arranged in the frame. For this purpose the crushing member can be connected to the top wall or the side wall, or the crushing member is connected to both top wall and side wall. Different spaces of garbage rooms may have different possibilities for the placement of the device according to the present invention. The advantage of the new device is that it can be built in different embodiments with different walls and that the crushing member can be connected to the frame in different ways. Preferably, the embodiment of the device can be adapted to the space in which the device is placed.

According to a further embodiment of the invention, at least two parallel side walls comprise at least a steering member and whereby the crushing member is at least movably connected to the two parallel side walls through the steering member. Steering members, such as for example a rail, can be constructed at a relative low cost.

According to an embodiment of the invention, the power means comprises a hydraulic activation member. Hydraulic power means are known as relatively simple to arrange at low construction costs.

According to another embodiment of the invention, the struts comprise bulges that protrude vertically towards the longitudinal axis of the first container and are configured to reduce space between the struts.

For the device to be able to be used continuously and with the least staff effort, it is important that no layer of crushed glass is formed on top of the struts. The layer forming can be prevented by a balanced interaction between the pressing force on the crushing member and the size of the spaces between the struts. The bulges on the struts reduce the space and are important for this interaction. Beside, the bulges help reducing the size of pieces of crushed glass objects.

According to a further embodiment of the invention, the device comprises a joint between the frame and the first container, whereby the joint is arranged to move the first container between a first orientation, where the upper opening allows the crushing member to be moved between the first position and the second position, and a second orientation, where the upper opening is orientated away from the crushing member.

The collected glass objects shall be placed in the first container. Therefore, it can be advantageously to be able to tilt the first container outwards so that it is easier and more convenient to place the glass object in the container. Especially when the device is placed in a smaller space, when one cannot stand in front of the device while placing the glass object in the container, it can be advantageous to be able to tilt the container outwards to be able to place the glass object from the side of the frame.

According to one embodiment of the invention, the first container comprises holes on opposite sides where the struts are inserted and secured.

The grid arrangement is exposed to pressing forces from the crushing member. The construction of the grid arrangement must be strong enough to be able to withstand the pressing forces. A strong construction can be provided by inserting the struts in the holes at the side of the first container and securing the struts on the side of the container by for example welding. Further the walls of the first container are preferably made of a material and have a thickness that can withstand the pressing forces.

The object is also achieved by a method defined in the pre characterized portion of claim 9, characterized in that the crushing member comprises a first surface that is directed towards the grid arrangement and the crushing member is configured to move between a first position and a second position, in which first position, the crushing member is outside the cavity and in which the second position, the crushing member is inside the cavity, whereby the first surface of the crushing member is configured to abut against the grid arrangement,

whereby the upper opening of the first container is configured for introduction of the crushing member,

the first surface of the crushing member comprises one or more protruding elements that protrude from the first surface and are configured to, in the second position, be inserted in the space between the struts of the grid arrangement, and

whereby the method comprises the following steps;
placing one or more glass object in the first container,
moving the crushing member towards the grid arrangement from the first position to the second position, and
moving the crushing member from the second position to the first position.

The method is simple to perform and requires no special education or knowledge from the staff. The method can be performed repeatedly so that the collected glass objects are crushed directly in the device without needing to be collected in files waiting to be crushed. The need for the garbage space reduces thereby. Also costs, including cost for work efforts, reduce by performing the method with the device according to the invention.

According to another embodiment of the method the crushing member is connected to a power means to provide a pressing force on the crushing member, that enables crushing of glass objects in the first container, and whereby the power means uses a higher pressing force in the second position compared to the pressing force used in the first position.

According to a further embodiment of the method the crushing member is adapted to move between a first level in the second position and a second level in the second position, in which second level the crushing member is closest to the grid arrangement, and whereby the power means uses a larger pressing force in the second level in the second position compared to the pressing force used in the first level in the second position.

According to another embodiment of the method, the interaction between the pressing forces and the size of the spaces between the struts of the grid arrangement is adapted to prevent the forming of a layer of pieces of glass objects on top of the grid arrangement. By a too low pressure or by a small space between the struts a layer can be formed. This could require cleaning of the grid arrangement and prevent the drift. A balanced interaction between the pressing forces and the size of the space between the struts may prevent forming of a layer.

The object is also achieved by a use of the above mentioned device for crushing glass objects in a shop, restaurant or hotel.

### DESCRIPTION OF THE DRAWINGS

FIG. 1 shows schematically an embodiment of the device.

FIG. 2 shows schematically a first container.

FIG. 3 shows schematically a grid arrangement.

FIG. 4 shows struts with bulges.

FIG. 5a shows schematically an embodiment of the device where the crushing member is in a first position.

FIG. 5b shows schematically an embodiment of the device where the crushing member is in a second position in a first level.

FIG. 5c shows schematically an embodiment of the device where the crushing member is in a second position in a second level.

FIG. 6 shows schematically an embodiment of the device where the first container is in a first orientation.

FIG. 7 shows schematically an embodiment of the device where the first container is in a second orientation.

FIG. 8 shows schematically an embodiment of the device where a door is closed.

### DETAILED DESCRIPTION OF AN EMBODIMENT OF THE INVENTION

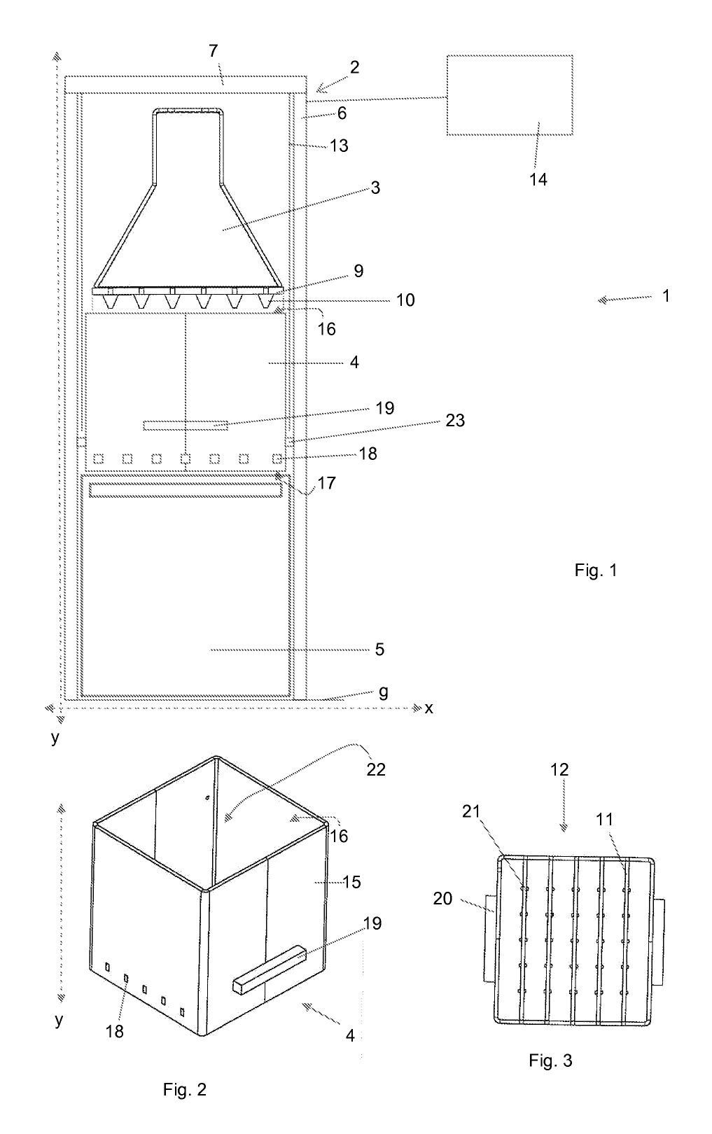

FIG. 1 shows an embodiment of the invention where a device 1 has a frame 2, which holds a crushing member 3 and a first container 4. FIG. 1 also shows a second container 5, which is placed directly under the first container 4.

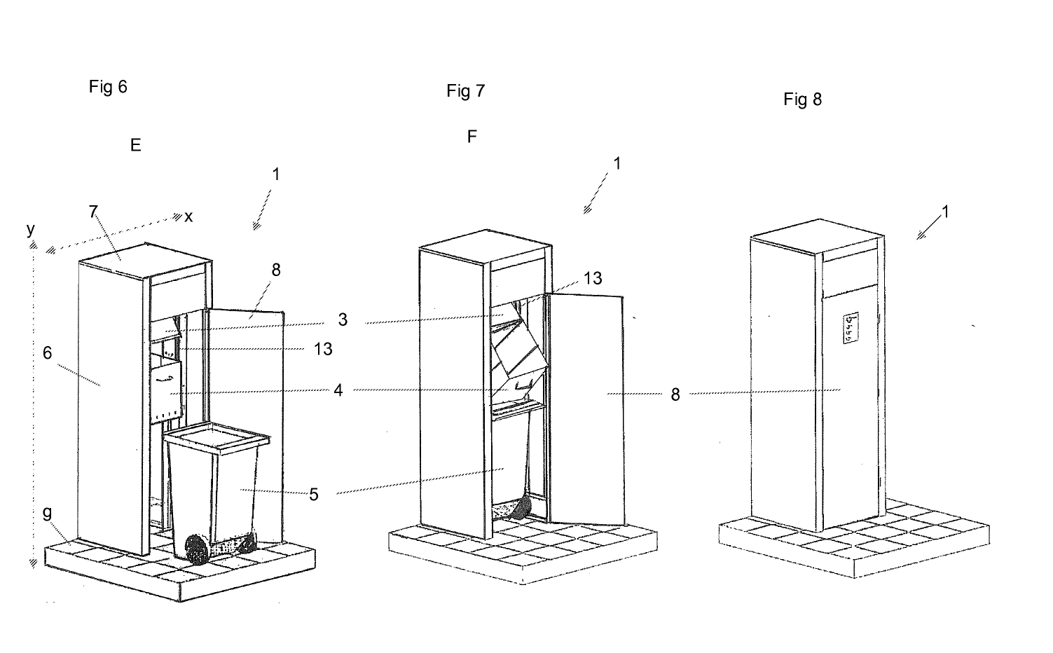

The frame 2 may be comprised of one or more poles 6 that extend along a longitudinal axis y from a ground level g to a connection 7 between one or more poles 6 or a wall in a building where the device 1 is placed. Connection 7 is arranged vertically above the crushing member 3 and may be a pole 7. Alternatively, the frame 2 may comprise two side walls 6 that extend along the longitudinal axis y between a ground level g and a top wall 7, whereby the top wall 7 is connected to the side walls 6 and extends along a substantially horizontal axis x (FIG. 6). The frame 2 may be formed in different ways and be adapted to a space in a building where the device 1 shall be placed. For the sake of simplicity, the word wall is used below for the description of the side and top of the frame 2.

The frame 2 may further comprise a door 8 connected to at least one side wall and configured to at least cover a portion of the surface between the top wall 7 and the other container 5 (FIG. 6, 7, 8).

The crushing member 3 is placed under the top wall 7 and comprises a first surface 9, which extends along the substantially horizontal axis x. This first surface 9 comprises protruding elements 10, which protrude from the first surface 9 down towards the ground level g. The protruding elements 10 are mutually separated with a space between the elements 10. The protruding elements 10 may extend horizontally over a portion or the full width of the first surface 9. In another embodiment, several protruding elements 10 (teeth) are present, separated from each other with a space between the different protruding elements 10 on the first surface 9. The vertical length of the protruding elements 10 may vary but is configured so that the elements 10 may be inserted in a space between the struts 11, which are present in a grid arrangement 12 in the first container 4. The first surface 9 with the protruding elements 10 is formed to be able to abut against the grid arrangement 12.

The crushing member 3 may be movably connected to the top wall 7 or one or more side walls 6. The crushing member 3 may also be movably connected to both the top wall 7 and one or more side wall 6. In one embodiment at lease two parallel side walls 6 comprise at least one steering member 13, whereby the crushing member 3 is at least movably connected to the at least two parallel side walls 6 through the steering member 13. An example of a steering member 13 is a rail, where the crushing member 3 can move itself up and down in a vertical direction along the rails.

The crushing member 3 is connected to a power means 14 to provide a pressing force on the crushing member 3, which enables crushing of one or more glass objects in the first container 4. The power means 14 may be a motor, such as an electrical driven motor. The power means 14 may also comprise a hydraulic activation member, such as a hydraulic pump. The power means 14 may be placed outside the frame 2 (FIG. 1) or the power means 14 is placed wholly or partially in the frame 2.

The crushing member 3 can be moved between a first position A and a second position B. In the first position A the crushing member 3 is placed above the first container 4 (FIG. 5a). In the second position B the crushing member 3 is placed in the first container 4 (FIG. 5b, 5c).

The pressing force may vary. For example may the pressing force vary between different positions and different levels of the crushing member 3 in relation to the distance from the grid arrangement 12. The pressing force may be lower in the first position A, where the crushing member 3 is outside the first container 4. Then, the crushing member 3 is led into the first container 4. The pressing force in this second position B may be divided in a first level C and a second level D, where the distance between the crushing member 3 and the grid arrangement 12 is larger in the first level C compared to the distance in the second level D.

The pressing force in the second position B is larger than the pressing force in the first position A. The pressing force that may be used when the crushing member 3 is in the first level C for crushing the glass objects, which are placed on top of the grid arrangement 12, may be less compared to the pressing force, which can be used in the second level D. In the first level C, the pieces of the crushed glass objects are pressed together while other pieces pass the grid arrangement 12. In the second level D, the glass objects, which abut against the grid arrangement 12, are crushed and the remaining pieces of crushed glass are pressed through the grid arrangement 12. Hereby can be prevented that a layer of pieces of crushed glass objects is formed on top of the grid arrangement 12. This is especially useful for preventing the formation of a layer on top of the grid due to thicker glass objects (thickness of more than 0.5 cm) and etiquettes on glass objects. The invention is not limited to the two positions and the two levels. Several positions and several levels in both positions can be used.

The power means 14 may be set or programmed to use different pressing forces in different positions and levels. For example may variations in pressing force vary depending on a distance of the crushing member 3 from the struts 11. Alternatively, the pressing forces may vary depending on a resistance that the crushing member 3 perceives when it is brought into the first container 4 against the glass objects. In that way, the pressing force may be varied depending on how many glass objects that shall be crushed.

The first container 4 comprises an elongated cylinder 15 with a vertical longitudinal axis y (FIG. 2). The first container 4 has an upper opening 16 and an under opening 17. The first container may comprise a handle 19.

The shape of the upper opening 16 and the cylinder 15 must complement the shape of the first surface 9 of the crushing member 3 so that it is configured for introduction of the crushing member 3 into the first container 4. The shape of the cylinder 15 may be round or rectangular, such as square.

The under opening 17 comprises a grid arrangement 12, which is shown in FIG. 3. The grid arrangement 12 comprises a plurality of elongated struts 11. These struts 11 are arranged between two opposite sides of the cylinder 15. The struts 11 are mutually separated with spaces between the struts 11.

In an alternative embodiment, the grid arrangement 12 also comprises crossing struts (not shown), which cross each other with an opening between the crossing struts 11. The spaces between the struts 11 are configured such that the protruding elements 10 of the crushing member 3 can be placed in the spaces between the struts 11. Pieces of crushed glass objects pass the grid arrangement 12 through the spaces between the struts 11.

The struts 11 are fixedly connected to the cylinder 15 of the first container 4. This connection is preferably strong enough to be able to withstand the pressing force from the crushing member 3. In one embodiment, the first container 4 comprises holes 18 on opposite sides of the container walls. The struts 11 can be inserted and secured in these holes 18. The struts 11 may for example be secured with a weld. Further connections may be arranged, such as for example one or more protruding parts 20 on the side of the grid arrangement 12, which can be inserted in hole 18 in one or more sides of the first container 4.

The struts 11 may have different shapes. In one embodiment, the struts 11 are substantially flat on the side that abuts against the crushing member 3. Alternatively, the struts 11 may wholly or partly be round, oval or rectangular, such as square.

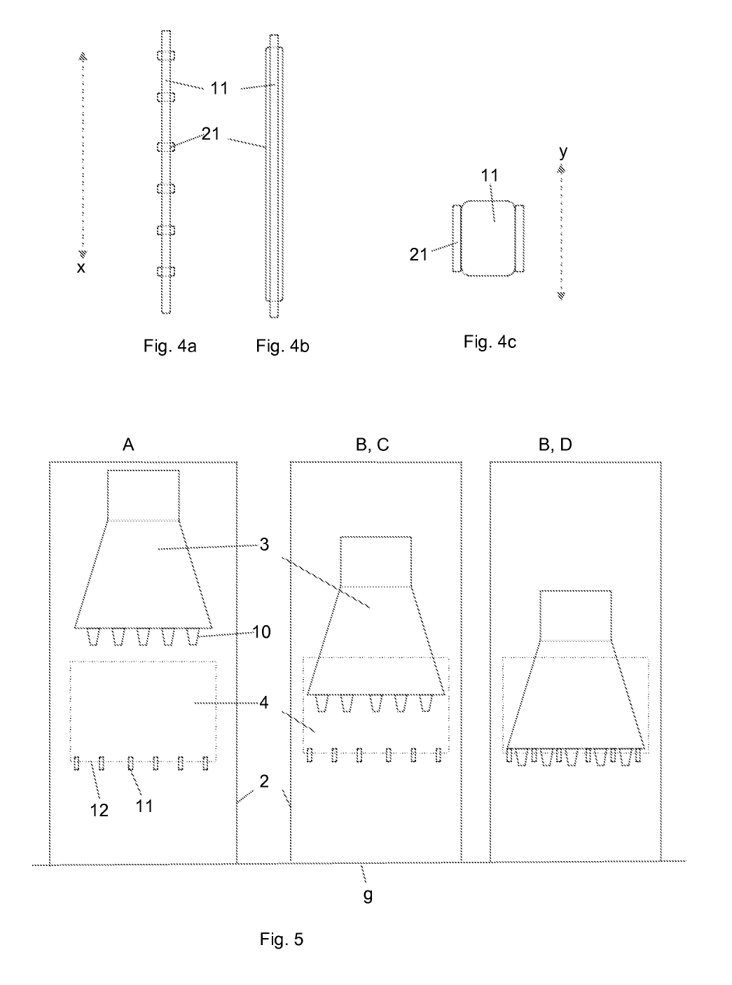

The struts 11 may comprise one or more bulges 21, which are shown in FIGS. 3 and 4. The bulges 21 are configured to reduce the spaces between the struts 11. In one embodiment, the bulges 21 protrude vertically against the longitudinal axis y (FIG. 4c). The struts 11 may have several bulges separated with a space between the bulges 21 (FIG. 4a). The struts 11 may also have a bulge 21 along substantially the whole length of the strut 11 (FIG. 4b). The invention is not limited to the two exemplified embodiments but includes all variations with bulges 21 in different length and shapes. The bulges 21 can be applied on the struts 11 by for example hardfacing.

A cavity 22 is defined between the upper opening 16 and the grid arrangement 12. The cavity 22 may have a volume, which is large enough to be able to receive one, preferably several glass objects. The volume may vary depending on the size of the device 1. In one example, the cavity 22 may have a volume of 40 to 100 liters, or 60 to 90 liters.

The device 1 may also comprise a joint 23 between the frame 2 and the first container 4. The joint 23 enables tilting of the first container 4 outwards. For example, the joint 23 may be arranged to move the first container 4 between a first orientation E, where the upper opening 16 allows the crushing member 3 to move into the container 4 and a second orientation F, where the upper opening 16 is orientated away from the crushing member 3 (FIGS. 6 and 7). The joint 23 may be connected in different ways between the frame 2 and the first container 4. For example, a pivotal connection may be used.

A safety device (not shown) may be connected to the crushing member 3. For example may the safety device be arranged to stop the power means 14 when opening the door 8. The safety device may also be connected to the joint 23 such that the crushing member 3 can only be moved into the second position B when the first container 4 is placed with the upper opening 16 extending along the horizontal axis x (i.e. in the first orientation E). The current may be disconnected when the first container 4 is not in the first orientation E and/or when the door 8 is opened.

All materials that are used for manufacturing the device 1 according to the present invention are preferably durable. This is especially important for the grid arrangement 12. One example of material that can be used for the grid arrangement 12 is cold strained hardened manganese steel.

The second container 5 may be arranged under the grid arrangement 12 for the collection of the pieces of crushed glass objects. This second container 5 is preferably replaceable and may be a bag or a container. In one embodiment, the second container 5 is a recycling container. The shape of the first container 4 may be designed after the shape of the second container 5.

The present invention also relates to a method for crushing one or more glass object, preferably recycling glass. For the execution of the methods the device described above is used. The device 1 may comprise all possible combinations of all features mentioned above.

In the new method one or preferably several glass objects are crushed, which have been placed in the first container 4. Possibly, the door 8 is opened and/or the first container 4 is tilted outwards so that the glass object can be placed in the first container 4. Then, the container 4 can be returned in the first orientation E and/or the door closed.

The crushing member 3 can be pressed down and thereby moved from the first position A to the second position B. The pressing force may be manually. Preferably, a power means 14 is used to move the crushing member 3. The pressing force may be less when the crushing member 3 is in the first position A. The pressing force may increase when the crushing member 3 is in the second position B and enters into the first container 4. The pressing force may be increased from the first level C to the second level D the closer the first surface 9 of the crushing member 3 comes towards the grid arrangement 12. In one example, a minor pressing force of 0.5 to 2 ton (50 to 200 kg) is used in the first position A and 0.5 to 5 ton in the second position B at the first level C. The pressing force increases to 7 to 11 ton in the second position B at the second level D. A higher pressure in the second level D prevents the formation of a layer of pieces of crushed glass. The pieces of crushed glass pass the grid arrangement 12 and may fall into the second container 5.

The crushing member 3 may be moved up after crushing of the glass to the first position A. The first container 4 can be filled again with collected glass objects. Alternatively, the first container 4 may be tilted into the second orientation F to facilitate the placing of the glass objects in the container 4.

To prevent the formation of a layer of pieces of glass objects on top of the grid arrangement 12 the interaction between the pressing force of the crushing member 3 and the size of the spaces between the struts 11 of the grid arrangement 12 can be adapted. Through routine testing the skilled worker can find the balance in the interaction.

Preferably, the device 1 controls with help of a computer.

The invention is not limited to the embodiments shown above but may be varied and modified within the frame work of the following claims.

1. A device for crushing of glass objects comprising
a first container (4) comprising an elongated cylinder (15) having a vertical longitudinal axis, an upper opening (16) and an under opening (17) comprising a grid arrangement (12) comprising a plurality of longitudinal struts (11) arranged between two opposite sides of the cylinder (15) and mutually separated with a space between the struts (11) arranged to allow passing of pieces of crushed glass objects,
whereby a cavity (22) is defined between the upper opening (16) and the grid arrangement (12) configured to receive one or more glass objects that shall be crushed,
a movable crushing member (3),
a frame (2) that holds the first container (4) and the crushing member (3),
characterized in that
the crushing member (3) comprises a first surface (9) that is directed towards the grid arrangement (12) and the crushing member (3) is configured to move between a first position (A) and a second position (B), in which first position (A) the crushing member (3) is outside the cavity (22), and in which second position (B) the crushing member (3) is inside the cavity (22), whereby the first surface (9) of the crushing member is configured to abut against the grid arrangement (12),
whereby the upper opening (16) of the first container (4) is configured for introduction of the crushing member (3),
the first surface (9) of the crushing member comprises one or more protruding elements (10) that protrude from the first surface (9) and are configured to, in the second position (B), be inserted in the space between the struts (11) of the grid arrangement (12).

2. The device (1) according to claim 1 characterized in that the crushing member (3) is connected to a power means (14) to provide a pressing force on the crushing member (3) that enables crushing of the glass object in the first container (4).

3. The device (1) according to claim 1 characterized in that the power means (14) uses a higher pressing force in the second position (B) compared to the pressing force used in the first position (A).

4. The device (1) according to claim 1 characterized in that the crushing member (3) is adapted to move between a first level (C) in the second position (B) and a second level (D) in the second position (B), in which second level (D) the crushing member (3) is closest to the grid arrangement (12), and whereby the power means (14) uses a larger pressing force in the second level (D) in the second position (B) compared to the pressing force used in the first level (C) in the second position (B).

5. The device (1) according to claim 1 characterized in that the device (1) comprises a second container (5) arranged under the grid arrangement (12) for collecting pieces of crushed glass objects.

6. The device (1) according to claim 1 characterized in that the frame (2) comprises at least two sidewalls (6) that extend along the longitudinal axis (y) between a ground level (g) and a top wall (7), whereby the top wall (7) is connected to the sidewalls (6) and extends along a substantially horizontal axis (x).

7. The device (1) according to claim 6 characterized in that the crushing member (3) is movably connected to the top wall (7) and/or one or more side walls (6).

8. The device (1) according to claim 1 characterized in that the struts (11) comprise bulges (21) that protrude vertically against the longitudinal axis (y) and are configured to reduce space between the struts (11).

9. The device (1) according to claim 1 characterized in that the device (1) comprises a joint between the frame (2) and the first container (4), whereby the joint (23) is arranged to move the first container (4) between a first orientation (E), where the upper opening (16) allows the crushing member (3) to move between the first position (A), and the second position (B), and a second orientation (F), where the upper opening (16) is orientated away from the crushing member (3).

10. A method for crushing glass comprising a device (1) comprising
a first container (4) comprising an elongated cylinder (15) having a vertical longitudinal axis (y), an upper opening (16), and an under opening (17) comprising a grid arrangement (12) comprising a plurality of longitudinal struts (11) arranged between two opposite sides of the cylinder (15) and mutually separated with space between the struts (11) configured to allow passing of pieces of crushed glass objects,
whereby a cavity (22) is defined between the upper opening (16) and the grid arrangement (12) configured to receive one or more glass objects that shall be crushed,
a movable crushing member (3),
a frame (2) that holds the first container (4) and the crushing member (3)
characterized in that
the crushing member (3) comprises a first surface (9) that is directed towards the grid arrangement (12) and the crushing member (3) is configured to move between a first position (A) and a second position (B), in which first position (A) the crushing member (3) is outside the cavity (22), and in which second position (B) the crushing member (3) is inside the cavity (22), whereby the first surface (9) of the crushing member is configured to abut against the grid arrangement (12),
whereby the upper opening (16) of the first container (4) is configured for introduction of the crushing member (3),
the first surface (9) of the crushing member comprises one or more protruding elements (10) that protrude from the first surface (9) and are configured to, in the second position (B), be inserted in the space between the struts (11) of the grid arrangement (12), and
whereby the method comprises the following steps;
placing one or more glass objects in the first container (4),
moving the crushing member (3) towards the grid arrangement (12) from the first position (A) to the second position (B), and
moving the crushing member (3) from the second position (B) to the first position (A).

11. The method according to claim 10 characterized in that the crushing member (3) is connected to a power means (14) to provide a pressing force on the crushing member (3), which enables crushing of glass objects in the first container (4), and whereby the power means (14) uses a higher pressing force in the second position (B) compared to the pressing force used in the first position (A).

12. The method according to claim 10 characterized in that the crushing member (3) is adapted to move between a first level (C) in the second position (B) and a second level (D) in the second position (B), in which second level (D) the crushing member (3) is closest to the grid arrangement (12), and whereby the power means (14) uses a larger pressing force in the second level (D) in the second position (B) compared to the pressing force used in the first level (C) in the second position (B).

13. The method according to claim 11 characterized in that the crushing member (3) is adapted to move between a first level (C) in the second position (B) and a second level (D) in the second position (B), in which second level (D) the crushing member (3) is closest to the grid arrangement (12), and whereby the power means (14) uses a larger pressing force in the second level (D) in the second position (B) compared to the pressing force used in the first level (C) in the second position (B).

14. The device (1) according to claim 2 characterized in that the power means (14) uses a higher pressing force in the second position (B) compared to the pressing force used in the first position (A).

15. The device (1) according to claim 3 characterized in that the crushing member (3) is adapted to move between a first level (C) in the second position (B) and a second level (D) in the second position (B), in which second level (D) the crushing member (3) is closest to the grid arrangement (12), and whereby the power means (14) uses a larger pressing force in the second level (D) in the second position (B) compared to the pressing force used in the first level (C) in the second position (B).

16. The device (1) according to claim 4 characterized in that the device (1) comprises a second container (5) arranged under the grid arrangement (12) for collecting pieces of crushed glass objects.

17. The device (1) according to claim 5 characterized in that the frame (2) comprises at least two sidewalls (6) that extend along the longitudinal axis (y) between a ground level (g) and a top wall (7), whereby the top wall (7) is connected to the sidewalls (6) and extends along a substantially horizontal axis (x).

18. The device (1) according to claim 7 characterized in that the struts (11) comprise bulges (21) that protrude vertically against the longitudinal axis (y) and are configured to reduce space between the struts (11).

19. The device (1) according to claim 8 characterized in that the device (1) comprises a joint between the frame (2) and the first container (4), whereby the joint (23) is arranged to move the first container (4) between a first orientation (E), where the upper opening (16) allows the crushing member (3) to move between the first position (A), and the second position (B), and a second orientation (F), where the upper opening (16) is orientated away from the crushing member (3).
